(19) United States
(12) Patent Application Publication
(10) Pub. No.: US 2007/0210287 A1
(43) Pub. Date: Sep. 13, 2007

(54) Transparent plastic articles having controlled solar energy transmittance properties and methods of making

(75) Inventor: Carlos Guerra, Fairfield, CT (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(73) Assignee: Spartech Corporation

(21) Appl. No.: 11/796,314

(22) Filed: Apr. 27, 2007

Related U.S. Application Data
(63) Continuation-in-part of application No. 11/370,613, filed on Mar. 8, 2006.

(51) Int. Cl. G02F 1/361; C08K 3/10

(52) U.S. Cl. 252/582; 524/403; 264/500; 264/109

(57) ABSTRACT

A method of making a transparent plastic article having controlled solar energy transmittance properties includes, in one embodiment, providing a fluid thermoplastic material, and adding from about 0.003 percent by weight to about 0.1 percent by weight of a blend of a perylene based dye and a nanoparticle hexabromide based IR absorber to form a mixture. The blend of perylene based die and nanoparticle hexabromide based IR absorber being capable of preferentially absorbing energy having wavelengths of about 700 nanometers (nm) to about 1100 nm, and the ratio of an amount of perylene based dye to the amount of nanoparticle hexaboride IR absorber comprising about 99:1 to about 1:99. The method further includes cooling the mixture to form a transparent thermoplastic article with controlled solar energy transmittance properties.

### CROSS REFERENCE TO RELATED APPLICATIONS

This application is a Continuation-In-Part of U.S. patent application Ser. No. 11/370,613 filed Mar. 8, 2006, which is hereby incorporated by reference in its entirety.

### BACKGROUND OF THE INVENTION

This invention relates generally to transparent plastic articles, and more particularly, to transparent plastic articles having a reduced solar energy transmittance over known transparent plastic articles.

Transparent plastics are sometimes used for windows in buildings, vehicles, airplanes, telephone booths, etc. Solar energy easily passes through transparent plastics and can raise the temperature of the area inside, for example, an airplane, and particularly the cockpit of an airplane.

There are a number of applications where plastics are used to allow the passage of useful visible light while at the same time controlling the amount of solar energy (heat) transmitted through the plastic. It is known to attempt to control the transmission of solar energy using thin films and coatings containing dyes, pigments carbon black, metal oxides, for example, FeOₓ, CoOₓ, CrOₓ, and TiOₓ, and metals, for example Ag, Au, Cu, Ni, and Al. However, these known films reduce both infrared light (heat) and visible light. However, when these films or coatings are applied to transparent plastic flat sheets, the resulting product usually cannot be thermoformed. Also, the coatings and films are difficult and expensive to apply to a formed shape.

### BRIEF DESCRIPTION OF THE INVENTION

In one aspect, a method of making a transparent plastic article having controlled solar energy transmittance properties is provided. The method includes providing a liquid thermoplastic material, and adding from about 0.003 percent by weight to about 0.1 percent by weight of a blend of a perylene based dye and a nanoparticle hexabromide based IR absorber to form a mixture. The blend of perylene based die and nanoparticle hexabromide based IR absorber being capable of preferentially absorbing energy between the wavelengths of about 700 nanometers (nm) to about 1100 nm, and the ratio of the amount of perylene based dye to the amount of nanoparticle hexaboride IR absorber being about 99:1 to about 1:99. The method further includes cooling the mixture to form a transparent thermoplastic article with controlled solar energy transmittance properties.

In another aspect, a transparent plastic article having a reduced energy transmittance over known transparent plastic articles is provided. The transparent plastic article is formed from components including a thermoplastic material and from about 0:003 percent by weight to about 0.1 percent by weight of a blend of a perylene based dye and a nanoparticle hexabromide based IR absorber. The blend of the perylene based dye and the nanoparticle hexabromide based IR absorber being capable of preferentially absorbing energy between the wavelengths of about 700 nm to about 1100 nm. The ratio of the amount of perylene based dye to the amount of nanoparticle hexaboride IR absorber is about 99:1 to about 1:99.

### DETAILED DESCRIPTION OF THE INVENTION

A transparent plastic article having controlled solar energy transmission properties and methods of making the article is described below in detail. The transparent plastic article is formed from a thermoplastic resin and about 0.003 to about 0.1 weight percent of a blend of infrared (IR) absorbing materials having the ability to preferentially absorb solar energy between the wavelengths of about 700 nm to about 11 00 nm. The blend of IR absorbing materials reduces the ratio of IR light vs. visible light transmitted through the plastic article. Because less IR light is transmitted for a given amount of visible light, less heat is transmitted through the transparent plastic article. This phenomenon is desirable in applications such as automobiles and aircraft where the interior space is small relative to the size of the windows and/or windshields. The blend of IR absorbing materials includes a perylene based dye and a hexaboride based nanoparticle IR absorber

In an exemplary embodiment, a transparent plastic article is formed from a thermoplastic material, for example, a thermoplastic resin or a monomer that is subsequently polymerized to form a solid thermoplastic resin, and about 0.003 to about 0.1 weight percent of a blend of IR absorbing materials having the ability to preferentially absorb solar energy between the wavelengths of about 700 nm to about 1100 nm. The blend of IR absorbing materials is dissolved and/or dispersed in the fluid form of the thermoplastic resin to form a mixture. In one embodiment, solid thermoplastic particles and/or pellets of the resin are melted by heating to produce a fluid thermoplastic resin before dissolving and/or dispersing the blend of IR absorbing materials in the resin. The mixture is then cast into a mold, cooled, and removed from the mold to form the transparent thermoplastic article. In another embodiment, the mixture is extruded through a die to form a continuous web which is then cooled to form a continuous sheet of the thermoplastic article, which can then be cut to a desired predetermined size. In one embodiment, the transparent thermoplastic article permits at least about 75 percent transmission of visible light, in another embodiment, at least about 50 percent transmission of visible light, and in another embodiment, at least about 15 percent transmission of visible light while absorbing solar energy having wavelengths of about 700 nm and about 1100 nm.

It should be understood that as used herein, “formed from” denotes open, e.g., “comprising”, claim language. As such, it is intended that a composition “formed from” a list of components be a composition that includes at least these recited components, and can further include other, nonrecited components, during the composition's formation, for example UV absorbers, surfactants, pigments, and the like.

The blend of IR absorbing materials are incorporated into the thermoplastic resin by any suitable method. Some non limiting examples include by using a mixing tank and a simple stirring apparatus, by using high energy dispersion equipment such as Cowles blades, mills, attritters, and the like, and by using an extruder. In one embodiment, the resin is heated to a temperature sufficient to melt the thermoplastic resin forming a fluid before incorporating the blend of IR absorbing materials. In another embodiment, the blend of IR absorbing materials are a solid material and is mixed with solid particles and/or pellets of the thermoplastic resin prior to heating and melting the resin. The blend of IR absorbing materials includes a perylene based dye and a nanoparticle hexaboride IR absorber. In one embodiment, the ratio of the amount of perylene based dye to the amount of nanoparticle hexaboride IR absorber is about 99:1 to about 1:99, in another embodiment about 75:1 to about 1:75, and in another embodiment about 50:1 to about 1:50.

The perylene chemical structure in the perylene based dyes used in the present invention can be modified by the addition of other chemical groups which can modify the maximum absorption region in the infrared spectrum. Perylene based dyes are commercially available from, for example, BASF Corporation under the Lumogen® IR trademark.

The nanoparticle hexaboride IR absorber includes particles of hexaboride having a particle size in one embodiment of about 200 nm or less, and in another embodiment of about 100 nm or less. The hexaboride is selected from YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof. The nanoparticle hexaboride IR absorber can also include particles of SiO₂, TiO₂, ZrO₂, Al₂O₃, or MgO having a particle size in one embodiment of about 200 nm or less, and in another embodiment of about 100 nm or less. The nanoparticle hexaboride IR absorber can also include other materials, for example, organic dispersing agents and/or organic solvents. Nanoparticle hexaboride IR absorbers are commercially available from, for example, Sumitomo Metal Mining Co., Ltd.

Suitable thermoplastic resins that can be used in embodiments of the present invention include, but are not limited to, acrylic resins, polycarbonate resins, styrene resins, and mixtures thereof. In one embodiment, the acrylic resin is formed by polymerizing an alkyl(meth)acrylate monomer. The acrylic resins can be copolymers of one or more alkyl esters of acrylic acid or methacrylic acid having from 1 to 20 carbon atoms in the alkyl group optionally together with one or more other polymerizable ethylenically unsaturated monomers. Suitable alkyl esters of acrylic acid or methacrylic acid include methyl(meth)acrylate, isobutyl(meth)acrylate, alpha-methyl styrene dimer, ethyl(meth)acrylate, n-butyl(meth)acrylate, and 2-ethylhexyl(meth)acrylate. Suitable other copolymerizable ethylenically unsaturated monomers include vinyl aromatic compounds such as styrene and vinyl toluene; nitriles such as acrylonitrile and methacrylonitrile; vinyl and vinylidene halides such as vinyl chloride and vinylidene fluoride and vinyl esters such as vinyl acetate. It should be noted that the term “(meth)acrylate” refers to both methacrylate and acrylate.

The invention will be further described by reference to the following examples which are presented for the purpose of illustration only and are not intended to limit the scope of the invention. Unless otherwise indicated, all amounts are listed as parts by weight.

### EXAMPLE I

Pigment colorants, a perylene based dye and a nanoparticle hexaboride IR absorber were compared to a blend of a perylene based dye and a nanoparticle hexaboride IR absorber by incorporating them into thermoplastic acrylic sheets. Sample A included a perylene based dye, Lumogen® IR788. Sample B included a nanoparticle hexaboride IR absorber, KHDS-872G2, Sample C included a blend of the perylene based dye, Lumogen® IR788 and the hexaboride IR absorber, KHDS-872G2, and Sample D, a comparative reference, included a blend of phthalo green and carbon black pigments. Table I below shows the composition of Samples A-D. The acrylic sheets were 0.125 inch thick and were produced by the cell casting method. The optical performance of Samples A-D was evaluated by two different methods. One method used theoretical calculations using the Lawrence Berkeley National Laboratory (LBNL) Optics Software, version 5. The other method utilized a solar energy collector. The device consists of two separate small enclosures with an opening in each. The thermoplastic samples tested were positioned to cover the openings. Inside each enclosure was a thermocouple wire connected to an instrument to measure the temperature. The device was placed outdoors with the openings facing the sun.

TABLE I

| Ingredients | A | B | C | D |
|---|---|---|---|---|
| Methyl Methacrylate | 99 | 99 | 99 | 99 |
| Monomer | | | | |
| Azo-Type Free Radical | 0.09 | 0.09 | 0.09 | 0.09 |
| Initiator | | | | |
| Chain Regulator | 0.02 | 0.02 | 0.02 | 0.02 |
| UV Absorber | 0.1 | 0.1 | 0.1 | 0.1 |
| Perylene-Based Dye* | 0.01 | 0 | 0.001 | 0 |
| Hexaboride IR | 0 | 0.032 | 0.028 | 0 |
| Absorber** | | | | |
| Phthalo Green + Carbon | 0 | 0 | 0 | 0.008 |
| Black Pigments | | | | |

*LUMOGEN IR 788 commercially available from BASF Corporation.
**KHDS-872G2 (containing LaB₆) commercially available from Sumitomo Metal Mining Co., Ltd.

Sample Preparation: The ingredients for each of Samples A-D were dissolved or dispersed in the acrylic monomer. The amounts of the perylene based dye, the hexaboride IR absorber, and the pigment colorants were selected so that Samples A-D each had a percent visible light transmission (VLT) of about 77. The mixture was degassed and then poured inside a casting mold. The mold consisted of two glass plates separated by a soft gasket material and the assembly was kept together by spring clamps. The molds containing the test mixtures were placed in air-circulating ovens to polymerize. The casting cycles are approximately 4 to 12 hours at about 60° C. followed by 1 to 3 hours at temperatures of about 100° C. or higher. A slow cooling period followed. At the end of the casting process, the clamps were removed and the glass plates were separated from the resulting acrylic sheet.

Test samples were cut from Samples A-D. The test samples were evaluated using a scanning spectrophotometer to obtain the spectral light transmission properties. These values were entered in the LBNL Optics Software to calculate their visible light transmission and solar energy transmission. The test samples of Samples A-D were also tested outdoors using the solar collector device described above. Table II below shows the percent visible light and the percent solar energy transmission calculated by the LBNL Optics Software for Samples A-D. As shown, Sample C permits the lowest percent solar energy transmission at 77% visible light transmission. The VLT/SET ratio of Sample C also indicates that Sample C permits the lowest percent solar energy transmission at 77% visible light transmission compared to Samples A, B, and D.

TABLE II

| | A | B | C | D |
|---|---|---|---|---|
| % Visible Light Transmission | 77 | 77 | 77 | 77 |
| (VLT) | | | | |
| % Solar Energy Transmission | 57 | 54 | 51 | 72 |
| (SET) | | | | |
| VLT/SET Ratio | 1.351 | 1.415 | 1.501 | 1.009 |

### EXAMPLE II

Pigment colorants, a perylene based dye and a nanoparticle hexaboride IR absorber were compared to a blend of a perylene based dye and a nanoparticle hexaboride IR absorber by incorporating them into thermoplastic acrylic sheets. In this example the amount of the perylene based dye, the hexaboride IR absorber, and the pigment colorants were selected so that Samples E-H, described below, each had a percent solar energy transmission (SET) of about 51. Sample E included a perylene based dye, Lumogen® IR788. Sample F included a nanoparticle hexaboride IR absorber, KHDS-872G2, Sample G included a blend of the perylene based dye, Lumogen® IR788 and the hexaboride IR absorber, KHDS-872G2, and Sample H, a comparative reference, included a blend of phthalo green and carbon black pigments. Table III below shows the composition of Samples E-H. The acrylic sheets were 0.125 inch thick and were produced by the cell casting method. The optical performance of Samples E-H was evaluated as described above in Example I.

TABLE III

| Ingredients | E | F | G | H |
|---|---|---|---|---|
| Methyl Methacrylate | 99 | 99 | 99 | 99 |
| Monomer | | | | |
| Azo-Type Free Radical | 0.09 | 0.09 | 0.09 | 0.09 |
| Initiator | | | | |
| Chain Regulator | 0.02 | 0.02 | 0.02 | 0.02 |
| UV Absorber | 0.1 | 0.1 | 0.1 | 0.1 |
| Perylene-Based Dye* | 0.015 | 0 | 0.001 | 0 |
| Hexaboride IR | 0 | 0.036 | 0.028 | 0 |
| Absorber** | | | | |
| Phthalo Green + Carbon | 0 | 0 | 0 | 0.028 |
| Black Pigments | | | | |

*LUMOGEN IR 788 commercially available from BASF Corporation.
**KHDS-872G2 (containing LaB₆) commercially available from Sumitomo Metal Mining Co., Ltd.

Sample Preparation: The ingredients for each of Samples E-H were dissolved or dispersed in the acrylic monomer. The mixture was degassed and then poured inside a casting mold. The mold consisted of two glass plates separated by a soft gasket material and the assembly was kept together by spring clamps. The molds containing the test mixtures were placed in air-circulating ovens to polymerize. The casting cycles are approximately 4 to 12 hours at about 60° C. followed by 1 to 3 hours at temperatures of about 100° C. or higher. A slow cooling period followed. At the end of the casting process, the clamps were removed and the glass plates were separated from the resulting acrylic sheet.

Test samples were cut from Samples E-H. The test samples were evaluated using a scanning spectrophotometer to obtain the spectral light transmission properties. These values were entered in the LBNL Optics Software to calculate their visible light transmission and solar energy transmission. The test samples of Samples E-H were also tested outdoors using the solar collector device described above. Table IV below shows the percent visible light and the percent solar energy transmission calculated by the LBNL Optics Software for Samples E-H. As shown, Sample G permits the highest percent visible light transmission at 51% solar energy transmission. The VLT/SET ratio of Sample G also indicates that Sample G permits the highest percent visible light transmission at 51% solar energy transmission compared to Samples E, F, and H.

TABLE IV

| | E | F | G | H |
|---|---|---|---|---|
| % Visible Light Transmission | 70 | 75 | 77 | 51 |
| (VLT) | | | | |
| % Solar Energy Transmission | 51 | 51 | 51 | 51 |
| (SET) | | | | |
| VLT/SET Ratio | 1.373 | 1.471 | 1.501 | 1.000 |

The above described Examples show that thermoplastic articles that include a blend of perylene based dye and hexaboride IR absorber transmit less solar energy than thermoplastic articles that include the perylene based dye alone or the hexaboride IR absorber alone at a much lower cost.

While the invention has been described in terms of various specific embodiments, those skilled in the art will recognize that the invention can be practiced with modification within the spirit and scope of the claims.

What is claimed is:

1. Method of making a transparent plastic article with controlled solar energy transmittance properties, said method comprising:
providing a fluid thermoplastic material;
adding from about 0.003 percent by weight to about 0.1 percent by weight of a blend of a perylene based dye and a nanoparticle hexabromide based IR absorber to form a mixture, the bend of perylene based die and nanoparticle hexabromide based IR absorber capable of preferentially absorbing energy having wavelengths of about 700 nm to about 1100 nm, a ratio of an amount of perylene based dye to an amount of nanoparticle hexaboride IR absorber comprising about 99:1 to about 1:99; and
cooling the mixture to form a transparent thermoplastic article with controlled solar energy transmittance properties.

2. A method in accordance with claim 1 comprising adding from about 0.005 percent by weight to about 0.05 percent by weight of the bend of perylene based die and nanoparticle hexabromide based IR absorber the perylene based die.

3. A method in accordance with claim 1 comprising adding from about 0.006 percent by weight to about 0.03 percent by weight of the bend of perylene based die and nanoparticle hexabromide based IR absorber.

4. A method in accordance with claim 1 wherein providing a thermoplastic material comprises providing a thermoplastic resin selected from acrylic resins, polycarbonate resins, styrene resins, and mixtures thereof.

5. A method in accordance with claim 4 wherein adding from about 0.005 percent by weight to about 0.05 percent by weight of the bend of perylene based die and nanoparticle hexabromide based IR absorber comprises at least one of dispersing the blend in the thermoplastic resin and dissolving the blend in the thermoplastic resin.

6. A method in accordance with claim 1 wherein providing a thermoplastic material comprises providing an alkyl(meth)acrylate monomer and wherein adding from about 0.005 percent by weight to about 0.05 percent by weight of the bend of perylene based die and nanoparticle hexabromide based IR absorber comprises dispersing the blend in the monomer.

7. A method in accordance with claim 6 further comprising polymerizing the monomer by heating the monomer and blend mixture.

8. A method in accordance with claim 1 further comprising:
heating the thermoplastic material and blend mixture;
directing the thermoplastic material and blend mixture into a mold;
cooling the mixture to form the transparent thermoplastic article; and
removing the transparent thermoplastic article from the mold.

9. A method in accordance with claim 1 further comprising:
directing the thermoplastic material and blend mixture through an extrusion die to form a continuous web of transparent thermoplastic material; and
cooling the continuous web of transparent thermoplastic material to form a transparent thermoplastic sheet.

10. A method in accordance with claim 1 wherein the nanoparticle hexabromide based IR absorber comprises hexabromide particles selected from the group consisting of YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof.

11. A method in accordance with claim 1 wherein the nanoparticle hexabromide based IR absorber comprises hexabromide particles having a particle size of about 200 nm or less.

12. A method in accordance with claim 1 wherein the nanoparticle hexabromide based IR absorber comprises hexabromide particles having a particle size of about 100 nm or less.

13. A transparent plastic article having a controlled solar energy transmittance properties, said transparent plastic article formed from components comprising:
a thermoplastic material; and
from about 0.003 percent by weight to about 0.1 percent by weight of a blend of a perylene based dye and a nanoparticle hexabromide based IR absorber, the blend of perylene based dye and nanoparticle hexabromide based IR absorber capable of preferentially absorbing energy having wavelengths of about 700 nm to about 1100 nm, a ratio of an amount of said perylene based dye to an amount of said nanoparticle hexaboride IR absorber comprising about 99:1 to about 1:99.

14. A transparent plastic article in accordance with claim 13 comprising from about 0.005 percent by weight to about 0.05 percent by weight of the blend of perylene based dye and nanoparticle hexabromide based IR absorber.

15. A transparent plastic article in accordance with claim 13 comprising from about 0.066 percent by weight to about 0.03 percent by weight of the blend of perylene based dye and nanoparticle hexabromide based IR absorber.

16. A transparent plastic article in accordance with claim 13 wherein said thermoplastic material comprises a thermoplastic resin selected from acrylic resins, polycarbonate resins, styrene resins, and mixtures thereof.

17. A transparent plastic article in accordance with claim 13 wherein said transparent plastic article is formed from said acrylic resin and said blend of perylene based dye and nanoparticle hexabromide based IR absorber, said acrylic resin comprising an alkyl(meth)acrylate monomer that has been polymerized after said blend of perylene based dye and nanoparticle hexabromide based IR absorber has been dispersed in said monomer.

18. A transparent plastic article in accordance with claim 13 wherein said nanoparticle hexabromide based IR absorber comprises hexabromide particles selected from the group consisting of YB₆, LaB₆, CeB₆, PrB₆, NdB₆, SmB₆, EuB₆, GdB₆, TbB₆, DyB₆, HoB₆, ErB₆, TmB₆, LuB₆, SrB₆, CaB₆, and mixtures thereof.

19. A transparent plastic article in accordance with claim 13 wherein said nanoparticle hexabromide based IR absorber comprises hexabromide particles having a particle size of about 200 nm or less.

20. A transparent plastic article in accordance with claim 13 wherein said transparent plastic article is formed in a mold or is formed as a continuous transparent plastic sheet.

21. A transparent plastic article in accordance with claim 13 wherein said transparent plastic article permits at least about 75 percent transmission of visible light.

22. A transparent plastic article in accordance with claim 13 wherein said transparent plastic article permits at least about 50 percent transmission of visible light.

23. A transparent plastic article in accordance with claim 13 wherein said transparent plastic article permits at least about 15 percent transmission of visible light.
